(19) United States
(12) Patent Application Publication
(10) Pub. No.: US 2020/0164839 A1
(43) Pub. Date: May 28, 2020

(54) Vehicle Wheel Well De-Icing Apparatus

(71) Applicant: Charles Noah Cook, Akwesasne (CA)

(72) Inventor: Charles Noah Cook, Akwesasne (CA)

(21) Appl. No.: 16/202,164

(22) Filed: Nov. 28, 2018

(51) Int. Cl. B60S 1/66; B62D 25/18

(52) U.S. Cl. CPC B60S 1/66; B62D 25/18

(57) ABSTRACT

A wheel well apparatus configured to be mounted within the wheel well of a motor vehicle wherein the wheel well apparatus is operable to inhibit accumulation of ice and dislodge any ice that has accumulated within the wheel well. The wheel well apparatus includes a body member that is arcuate in form so as to mateably mount within the wheel well of a motor vehicle. The body member includes a plurality of walls forming an interior volume that is hollow. The body member has operably coupled thereto a plurality of air ducts that are coupled to the heater of the vehicle. The air ducts are configured to direct hot air into the interior volume of the body member. A pressure release valve is coupled to the interior volume of the body member. The inner wall has a movable portion configured to provide dislodging of ice accumulation.

### FIELD OF THE INVENTION

The present invention relates generally to motor vehicle equipment, more specifically but not by way of limitation, an apparatus for a motor vehicle that is configured to either inhibit or remove ice accumulation within the interior of the wheel wells of the motor vehicle.

### BACKGROUND

Millions of individuals routinely operate motor vehicles in inclimate conditions such as but not limited to rain and snow. Driving a vehicle in adverse conditions offers challenges both for road safety as well as vehicle maintenance. By way of example but not limitation, when motor vehicles are operated in freezing conditions it is quite common for accumulation of snow and/or ice on various portions of the vehicle. For example, snow and ice regularly accumulate on the top of vehicles and trailers and as these vehicles traverse down the road the dislodging of the accumulation can create a safety hazard from other vehicles on the road. Other areas of motor vehicles also have the propensity to develop accumulation of ice such as but not limited to the interior of wheel wells of the motor vehicle.

Several issues can arise with the accumulation of ice on the interior surface of the wheel wells of vehicles. One issue is the safety hazard that the ice accumulation presents. The accumulated ice can dislodge during vehicle operation, which can present a safety hazard to other vehicles in the area or can cause damage to the vehicle itself. Significant ice accumulation in a wheel well can cause damage to the tire as well as inhibit movement thereof. Due to the aforementioned risks, owners of vehicles will attempt to remove and/or dislodge ice that has accumulated within the wheel well of their vehicle. There are no existing tools that are designed for this task and as a result owners will try using shovels and other equipment that not only are ineffective at removing the ice but most often will result in damage to the vehicle.

Accordingly, there is a need for a wheel well de-icing apparatus that is configured to both inhibit the accumulation of ice within a wheel well and assist in the removal of any ice that may have accumulated within the interior of the wheel well.

### SUMMARY OF THE INVENTION

It is the object of the present invention to provide a de-icing apparatus for a wheel well that is configured to inhibit and/or remove ice therefrom that includes a body member disposed within the wheel well of a vehicle.

Another object of the present invention is to provide a wheel well de-icing apparatus that is operable to inhibit ice accumulation within a wheel well of a vehicle wherein the body member includes a plurality of walls and further has an interior volume.

A further object of the present invention is to provide a de-icing apparatus for a wheel well that is configured to inhibit and/or remove ice therefrom wherein the interior volume of the body member is operably coupled to the heating system of the vehicle.

Still another object of the present invention is to provide a wheel well de-icing apparatus that is operable to inhibit ice accumulation within a wheel well of a vehicle that further includes a plurality of air ducts that are pneumatically coupled to the heat generation system of the vehicle and the interior volume of the body member.

An additional object of the present invention is to provide a provide a de-icing apparatus for a wheel well that is configured to inhibit and/or remove ice therefrom wherein one of the walls of the body member adjacent to the void in the wheel well includes a movable portion configured to move downward to facilitate ice removal.

Yet a further object of the present invention is to provide a wheel well de-icing apparatus that is operable to inhibit ice accumulation within a wheel well of a vehicle wherein the movable portion of the wall of the body member is operably coupled to a pneumatic cylinder wherein the pneumatic cylinder is configured to provide operation of the movable portion.

Another object of the present invention is to provide a provide a de-icing apparatus for a wheel well that is configured to inhibit and/or remove ice therefrom wherein the body member further includes a pressure release valve configured to provide control of the air pressure within the interior volume of the body member.

An alternate object of the present invention is to provide a wheel well de-icing apparatus that is operable to inhibit ice accumulation within a wheel well of a vehicle wherein the body member is manufactured from a material that is rigid and has appropriate heat retention and conduction.

Still a further object of the present invention is to provide a de-icing apparatus for a wheel well that is configured to inhibit and/or remove ice therefrom that includes a control unit disposed within the passenger compartment of the vehicle wherein the control unit is configured to operate the first removal and second removal techniques of the de-icing apparatus.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention disposed within an exemplary vehicle; and

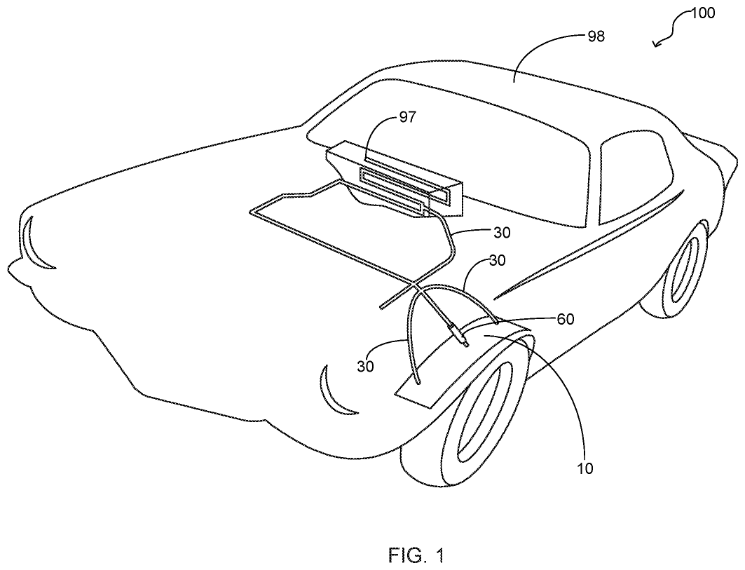

FIG. 2 is a side view of the present invention; and

FIG. 3 is a bottom view of the body member illustrating a movable portion of the outer wall of the body member.

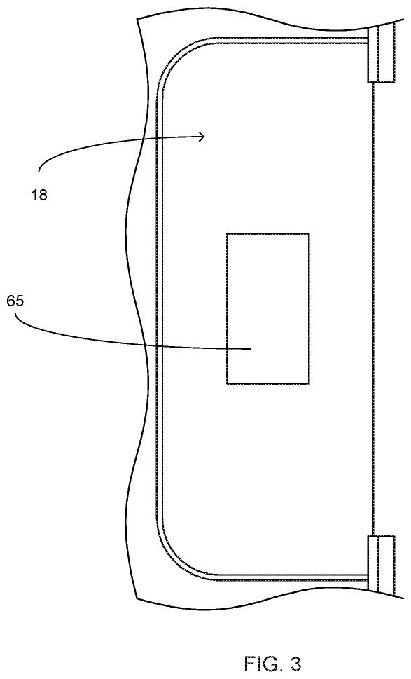

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle wheel well de-icing apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

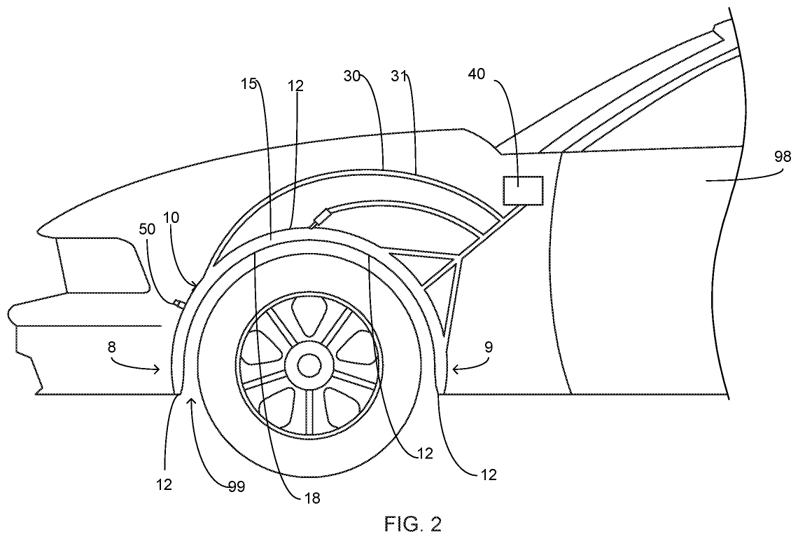

Referring in particular the Figures submitted as a part hereof, the vehicle wheel well de-icing apparatus 100 includes a body member 10 that is mounted within the wheel well 99 of a vehicle 98. The body member 10 includes a plurality of walls 12 integrally formed utilizing suitable techniques wherein the plurality of walls 12 are configured to define an interior volume 15. The interior volume 15 is hollow and is configured to receive air therein from the car heater 97 as will be further discussed herein. The body member 10 includes a first end 8 and second end 9 and is formed so as to be substantially the length of the interior of the wheel well 99. While it is desired within the scope of the present invention that the body member 10 be manufactured of a size that is similar to that of the wheel well 99, it should be understood within the scope of the present invention that the body member 10 could be manufactured in alternate sizes so as to line only a portion of the wheel well 99 or the entire wheel well 99 as illustrated herein in FIG. 2.

The body member 10 is manufactured from a durable material such as but not limited to metal. Metal is a preferred material for the walls 12 of the body member 10 for at least two reasons. First, a body member 10 manufactured from metal is more durable and can withstand contact from debris that can be introduced into the wheel well 99 during operation of the vehicle. Secondly, as the body members 10 purpose to maintain a temperature that is greater than freezing in order to inhibit ice accumulation or provide removal thereof, a metal body member 10 provides the heat conductance and retention that is desirable for the present invention. It is contemplated within the scope of the present invention that the body member 10 could be manufactured from alternate types of metals and achieve the desired objective as described herein. The body member 10 is arcuate in shape having a similar radius to that of the wheel well 99.

The body member 10 is pneumatically coupled to the car heater 97 utilizing air ducts 30. The air ducts 30 are manufactured from a suitable durable material and include a hollow passage 31 that is configured to facilitate airflow from the car heater 97 to the interior volume 15 of the body member 10. As is known in the art, car heaters 97 produce warm air that is typically around one hundred and thirty degrees Fahrenheit at its maximum. This warm air is distributed into the passenger compartment utilizing a plurality of vents and the temperature output is controlled by an operator of the vehicle 98. The air ducts 30 are configured to be pneumatically coupled to the car heater 97 and direct the warm air produced thereby into the interior volume 15 of the body member 10. The temperature of the air introduced into the interior volume 15 of the body member 10 is such that the temperature of the walls 12 increase to a temperature that will either inhibit ice formation thereon or will remove ice that has accumulated. While a plurality of air ducts 30 are illustrated herein, it should be understood within the scope of the present invention that the vehicle wheel well de-icing apparatus 100 could employ as few as one air duct 30 or more than one air duct 30 so as to distribute warm air into the interior volume 30 of the body member 10. The air ducts 30 are operably coupled to the controller 40 of the vehicle wheel well de-icing apparatus 100 wherein the controller 40 provides the interface necessary for a user to activate the flow of air into the air ducts 30 from the car heater 97. It is contemplated within the scope of the present invention that the controller 40 could provide operation of the vehicle wheel well de-icing apparatus 100 utilizing either manual gate style controls or electronic controls wherein either are configured to allow air to flow into the body member 10 or inhibit airflow into the interior volume 15 of the body member 10.

A pressure release valve 50 is secured to the body member 10. The pressure release valve 50 is operable to inhibit a pressure increase within the interior volume 15 of the body member 10 as airflow is being introduced thereinto from the air ducts 30. In order to eliminate any back pressure as a result from airflow into the interior volume 15 of the body member 50, the vehicle wheel well de-icing apparatus 100 includes at least one pressure release valve 50 that is calibrated to release air from the interior volume 15 of the body member 10 at a pressure that avoids any backwards airflow or backpressure on the car heater 97. The pressure release valve 50 is a conventional pressure release valve and it is contemplated within the scope of the present invention that the body member 10 could have more than one pressure release valve 50 in order to achieve the desired objective of preventing back pressure on the car heater 97.

The vehicle wheel well de-icing apparatus 100 further includes a pneumatic cylinder 60 that is operably coupled with wall portion 65. Wall portion 65 is formed within the inner wall 18 of the body member 10. The wall portion 65 is configured to move in a first direction and a second direction wherein in the first direction the wall portion 65 is extended outward from beyond the inner wall 18 towards the wheel well 99. The aforementioned movement of the wall portion 65 is operably controlled by the pneumatic cylinder 60. The movement of the wall portion 65 function to assist in the dislodging of any ice accumulation within the wheel well 99. The wall portion 65 is only a portion of the area of the surface area of the inner wall 18 as to objective is to engage a section of accumulated ice and provide leverage thereagainst in order to facilitate the removal of the ice from the wheel well 99. While a single wall portion 65 has been illustrated herein, it is contemplated within the scope of the present invention that the vehicle wheel well de-icing apparatus 100 could include more than one wall portion 65. Furthermore, it is additionally contemplated within the scope of the present invention that the wall portion 65 could be formed in alternate shapes and sizes. Moreover, the wall portion 65 could be located in alternate positions on the inner wall 18 wherein positioning thereof could be determined by the likelihood of ice accumulation along a particular area within the wheel well 99.

The pneumatic cylinder 60 is operably coupled to the wall portion 65 of the inner wall 18 utilizing suitable mechanical fasteners. The pneumatic cylinder is a conventional cylinder having a piston that is configured to be moved in an inwards-outwards direction. The movement of the piston provides the first directional movement and second directional movement of the wall portion 65. In the first directional movement the wall portion 65 is extended outward from the inner wall 18. This first directional movement will apply a force from the wall portion 65 to any ice accumulation or portion thereof engaged therewith so as to dislodge from the wheel well 99. The second directional movement of the wall portion 65 is comprised of the wall portion 65 being returned to a position such that the wall portion 65 is aligned and generally flush with the inner wall 18.

While a pneumatic cylinder 60 is discussed herein so as to utilize an existing air supply from the air ducts 30 for operation, it is contemplated within the scope of the present invention that the pneumatic cylinder 60 could be replaced with an electrically operated hydraulic cylinder or other suitable device that could provide the first directional and second directional movement of the wall portion 65. It is further contemplated within the scope of the present invention that the vehicle wheel well de-icing apparatus 100 could have a single pneumatic cylinder 60 operably coupled to a single wall portion 65 or alternatively the vehicle wheel well de-icing apparatus 100 could employ more than one pneumatic cylinder 60 to provide independent operation of a plurality of wall portions 65. It should be understood within the scope of the present invention that the vehicle wheel well de-icing apparatus 100 can be mounted in all of the wheel wells 99 of a vehicle 98. It should also be understood within the scope of the present invention that the vehicle wheel well de-icing apparatus 100 could be installed as an aftermarket product or be configured to be integrated into the manufacturing of a new vehicle. Furthermore, it is additionally contemplated within the scope of the present invention that the heat source for the body member 10 could be an alternative source from the car heater 97 as described herein. It is anticipated within the scope of the present invention that heating elements could be additionally installed in the body member 10 and be electrically coupled to the electrical system of the vehicle 98. It is further contemplated within the scope of the present invention that a coating could be applied to the inner wall 18 so as to further inhibit the accumulation of ice thereon. Those skilled in the art will recognize that the coating could be manufactured from various substances in order to achieve the desired result of a reduced friction surface of the inner wall 18.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A wheel well apparatus installed in at least one wheel well of a vehicle wherein the wheel well apparatus is operable to inhibit ice accumulation or provide removal of an accumulation of ice wherein the wheel well apparatus comprises:
a body member, said body member having a plurality of walls configured to form an interior volume, said interior volume of said body member being hollow, said body member being formed so as to be mounted in at least a portion of a wheel well of a vehicle, said body member being manufactured from a rigid material;
at least one air duct, said at least one air duct being operably coupled to said interior volume of said body member, said at least one air duct further being operably coupled to a heater of the vehicle in which the wheel well apparatus is mounted, said at least one air duct configured to direct warm air from the heater to the interior volume of the body member so as to inhibit or remove any ice accumulated within the wheel well.

2. The wheel well apparatus as recited in claim 1, and further including a controller, said controller being disposed within a passenger compartment of the vehicle, said controller configured to provide operation of the wheel well apparatus.

3. The wheel well apparatus as recited in claim 2, wherein said body member further includes an inner wall, said inner wall of said body member being adjacent the wheel well of a vehicle.

4. The wheel well apparatus as recited in claim 3, and further including at least one wall portion, said at least one wall portion being formed in said inner wall, said at least one wall portion having a first position and a second position, wherein in said first position said at least one wall portion is moved outwards from said inner wall.

5. The wheel well apparatus as recited in claim 4, and further including at least one cylinder, said at least one cylinder operably coupled to said at least one wall portion, said at least one cylinder configured to provide the first position and second position of said at least one wall portion.

6. The wheel well apparatus as recited in claim 5, and further including at least one pressure release valve, said at least one pressure release valve operably coupled to the interior volume of the body member, said at least one pressure release valve configured to inhibit pressure buildup in the interior volume of said body member.

7. The wheel well apparatus as recited in claim 6, wherein the body member is manufactured from metal.

8. A wheel well apparatus disposed within a wheel well of a motor vehicle that inhibits ice accumulation and is configured to provide removal thereof comprising:
a body member, said body member being arcuate in shape having a radius equivalent to that of the wheel well, said body member configured to substantially line the wheel well, said body member having a plurality of walls configured to form an interior volume, said interior volume of said body member being hollow, said plurality of walls including an inner wall, said inner wall of said body member being adjacent the wheel well of the motor vehicle, said body member being manufactured from a rigid heat conducting material;
a plurality of air ducts, said plurality of air ducts being operably coupled to said interior volume of said body member, said plurality of air ducts further being operably coupled to a heater of the vehicle in which the wheel well apparatus is mounted, said plurality of air ducts configured to direct warm air from the heater to the interior volume of the body member so as to inhibit or remove any ice accumulated within the wheel well; and
a controller, said controller being disposed within a passenger compartment of the vehicle, said controller providing an interface for operation of the wheel well apparatus.

9. The wheel well apparatus as recited in claim 8, and further including a plurality of wall portions, said plurality of wall portions being formed in said inner wall, said plurality of wall portions having a first position and a second position, wherein in said first position said plurality of wall portions are moved outwards from said inner wall.

10. The wheel well apparatus as recited in claim 9, wherein in said second position said plurality of wall portions are flush with the inner wall of the body member.

11. The wheel well apparatus as recited in claim 10, and further including at least one pressure release valve, said at least one pressure release valve operably coupled to the interior volume of the body member, said at least one pressure release valve configured to inhibit pressure buildup in the interior volume of said body member.

12. The wheel well apparatus as recited in claim 12, and further including at least one pneumatic cylinder, said at least one pneumatic cylinder operably coupled to said plurality of wall portions, said at least one pneumatic cylinder configured to provide the first position and second position of said plurality of wall portions.

13. The wheel well apparatus as recited in claim 12, wherein said body member is manufactured from metal.

14. The wheel well apparatus as recited in claim 13, wherein the wheel well apparatus further includes electrical heating elements disposed in the body member thereof.
